(19) United States
(12) Patent Application Publication
(10) Pub. No.: US 2006/0122903 A1
(43) Pub. Date: Jun. 8, 2006

(54) Cross-Cultural and Personality Support System and Method

(76) Inventors: Guillermo Alberto Medrano, Highland Mills, NY (US); Mateo Dylan Ward, Miami, FL (US); Steven Sikes, Miami, FL (US); Stephen William Anthony Sanders, Tiburon, CA (US)

Correspondence Address: STEVEN SIKES, 4070 WOODRIDGE RD, MIAMI, FL, 33133, US

(21) Appl. No.: 11/307,860

(22) Filed: Feb. 25, 2006

(51) Int. Cl. G06Q 30/00

(52) U.S. Cl. 705/26

(57) ABSTRACT

A system and method for facilitating communication based on cross-culture and personality components. The system provides for real-time interaction with cross-culture experts and an automated platform that provides for customization based on several metrics, including culture and personality.

### FIELD OF THE INVENTION

The present invention is in the field of cross-cultural communication and personality assessment, specifically a system and method to provide supporting information, guidance, strategies, methods, models, and suggestions on how to facilitate communication across barriers and to enhance the presentation, purchase, and sale of products and services in the global marketplace based on several factors, including culture and personality.

### BACKGROUND OF THE INVENTION

Advances in technology, transportation, and communication have created a true global village where individuals and organizations interact, exchange information, and collaborate even when social, religious, cultural, commercial, and political differences can present barriers to successful communication. There exist cultural components, mores, and dynamics to provide roadmaps to facilitate successful cultural interaction; however, an automated system based on existing models and knowledge would provide broad access to cross-culture expertise and guidance based on personalized needs.

All manner of organizations benefit from collaboration and cooperation of their constituents. Commerce, industry, medicine, finance, education and science are areas of human endeavors relying on interaction between persons of varied cultures. The system and method of the present invention provides cross cultural information, guidance, strategies, methods, models, and suggestions to maximize the success of any cross cultural interaction, either for personal reasons, for example, while traveling across borders or forging relationships, or to achieve professional goals, for example, building global teams or presenting products and services to customers of diverse cultures. In addition, because of the accelerated demand for increasingly effective collaboration, the increased interaction of individuals via messaging and global communication technology, the outsourcing of knowledge work across cultures, and the increased amount of international travel across time zones, multinational companies, governmental organizations, militaries, and academic institutes are looking for ways to train their staff and employees to become “worldwise” and to enhance communication when interacting across borders.

Organizations are increasingly challenged by the daunting task of extracting more value from their members, necessitating cooperation and teamwork across cultural divides. More organizations need to communicate with their globally diverse workforces. More U.S. companies are hiring high-tech employees from foreign cultures.

Globalization is increasing the need to interact, manage, negotiate, and work effectively with peoples from different cultures. The velocity at which information and news are received across the Internet and mobile communication networks is affecting the global economy. Web-based technologies, digital collaboration tools, and interactive entertainment convergence are omnipresent. Communication across language and cultural barriers is essential to expansion into foreign markets as well as to the successful completion of online transactions where people from different cultures need to interact online or in real-time, via voice, video, or text to participate in auctions, carry-out price or contract negotiations and perform all kinds of ecommerce—and mobile commerce related interactions.

The primary reason for failure in the global market is cultural differences, misunderstandings, and insensitivities. Moreover, messages are translated incorrectly, inappropriate media are used, regulations are overlooked and economic or taste differences are ignored. Inappropriate product and company names introduced in foreign markets cause problems, misunderstandings, and economic loss. Communication problems, narrow-focused promotional strategies, and cultural differences cause major marketing mistakes. Uninformed managers, not aware of cultural differences, have difficulties handling international assignments. More organizations need to develop programs to train their employees when going global and to reframe strategies for presenting their products and services based on a worldwide, country-specific and regional basis.

The average cost of a relocation assignment for a U.S. company is over $1 million. The average premature return is 20%. Many multinational companies, based in the U.S.A., have experienced failure rates of over 60%. European and Japanese multinationals have lower failure rates with “expats” because their companies select and train people more extensively at living and working in foreign environments. Going abroad offers many opportunities, but it also presents new challenges, since working with foreign clients and associates increases the possibility of cultural misunderstandings. Decision-makers at organizations today must now visualize the marketplace in multinational terms. As critical as the delivery of cross-cultural expertise to expats and corporations is, this current need will soon be dwarfed by the rapidly evolving need for the delivery of cross-cultural expertise in the online marketplace since consumers and corporations are increasingly choosing to use the global computer networks to carry out global business plans rather than the physical relocation of offices and employees.

The invention will function using, but not be limited to, one or more cross-cultural processing engines. Processing engines would include the programs and platforms of interaction and assistance by cross-culture experts.

The expert knowledge system also contains new cultural metrics and comparison systems to reflect the ever-changing global and cross-cultural parameters. Requestors select cultural tests to assess their cross-culture awareness, as well as, personality tests to assess characteristic traits and to predict behaviors. The expert knowledge system then produces information, instructions, strategies, methods, models, and suggestions based on the results of the assessment tools.

Personalization is becoming essential to the customer who has greater choices; finding ways to present products and services tailored to an individual's needs based on personality can help marketers design customized solutions for customers and prospective customers. Based on previous searches and purchases, ecommerce companies like Amazon.com and eBay can present categorical alternatives and similar choices. By taking a survey or enabling marketers to use information based on data mining or click-stream activity, customers provide marketers with information which can be used to develop personality profiles of customers and prospective customers and customized interfaces for facilitating commerce in real time either in e-(electronic) or m-(mobile) commerce.

Heretofore, inventors have created and developed systems and methods to deliver cross cultural interaction information for any combination of human cultures. The present invention is designed to help participants in any cross cultural interaction achieve greater success through better cultural understanding and communication. Inventors have created and developed a system and method that can be delivered by a human being or by interacting with a combination of memory storage and logic processing devices such as computers and internet-enabled computing systems. In addition to the cross cultural support platform, the present invention has a provision to optionally supply personality assessment of individuals who will be collaborating on a multicultural project. This system and method can be provided from a computer database or provided from devices and facilities via local or global communication networks, including the Internet, Intranets, Extranets, television, mobile communication, cellular, wireless, Voice over IP (VoIP) and satellite networks.

U.S. Pat. No. 6,963,871 (Hermansen; John Christian, et al., 2005), expressly incorporated herein by reference, relates to executing a name search, using various linguistic algorithms to compare input name with databased names. This is purely a name searching invention, developed with using phonological features, orthographic features, semantic features, syntactic features, n-gram based features, the number of elements in names, the types of elements in names, variations in spelling of a name, accounting for exclusion of expected information in a name and positional information of names to get a match. There is no reference to cross-cultural interaction or cultural information interchange.

U.S. Pat. No. 6,886,000 (Alok, et al., 2005), expressly incorporated herein by reference, relates to a system and method for profiling e-commerce participants and attempts to “change their negotiation strategy in a dynamic and an on-line manner.” This invention deals solely with e-commerce, and uses “cultural upbringing” as an attribute in profiling participants, never referencing the facilitation of cross cultural interactions.

U.S. Pat. No. 6,469,713 (Hetherington, et. al. 2002) expressly incorporated herein by reference, relates to changing display language on a computer screen in relation to a user's culture. This existing art does not support cross cultural interaction.

U.S. Pat. No. 6,199,067 (Geller 2001) expressly incorporated herein by reference, defines a system and method for automatically generating personalized user profiles for automated searches. It uses cultural identity only to enhance the accuracy of matches.

U.S. Pat. No. 5,835,768 (Gary Wayne Miller et. al. 1998) expressly incorporated herein by reference, relates to a system that presents information based on a users cultural preferences. This system makes no mention of support cross cultural interaction.

U.S. Pat. No. 5,871,211 (Was; Michael C. 1999) expressly incorporated herein by reference, discloses a method and device for typing thinking styles. No mention or functionality exists of combining thinking styles with cultural characteristics, mores, customs and dynamics to support cross cultural interaction.

U.S. Pat. No. 6,159,015 (Buffington et. al. 2000) expressly incorporated herein by reference, relates to a method and system for measuring the development level of the natural temperament, degrees of positive and negative behaviors adopted by an individual, and reactionary pattern and style as predictors of the individual's current level of personal effectiveness. The method includes administering two separate profiling instruments, a temperaments type and a preferences type. The two are then correlated and adjusted to be congruent. A third instrument is used to assess positive and negative traits within each profile type. This invention provides a foundation for assessing individual personal effectiveness as a component of a cross cultural interaction; however it lacks the functionality that is claimed by this invention such as a dynamic cross-culture and personality support platform and engine that facilitates communication and provides for customization and personalization in real-time.

The invention may use specific platforms that will connect users of the invention to the Internet. Such platforms may include but not be limited to a Language Translation System and Method, or other platforms that would allow the user of this invention to view a Graphic User Interface (GUI) over a mobile phone, computer, kiosk, television screen or other screen in order to facilitate the use of this invention. Users of this invention can access this invention via a plurality of methods.

### SUMMARY OF THE INVENTION

The present invention relates to a system and method that provides cross cultural interaction information, instructions, strategies, methods, models, and suggestions. In one arrangement, two or more cultures and the type of cultural interaction that needs support are filtered to an expert knowledge system. The request originator selects a cross-cultural processing engine. The expert knowledge system then produces information, instructions, strategies, methods, models, and suggestions based on the specific cultures and interaction that were described.

In another arrangement, a cultural expert is consulted via an online, Internet-based Translation Platform, including but not limited to a Translation and Global Communication Facilitator System. The interacting cultures are described; the context of the interaction is defined, and the cultural expert produces supporting information, instructions, strategies, methods, models, and suggestions.

In another arrangement, a series of cultures are described to the expert knowledge system and the system produces information supporting how best the cultural components described can interact within the confines of said description.

In another arrangement, personality support is requested. As with the cross cultural processing engine, this personality assessment component will provide essential information to develop strategies and suggestions to support the interaction of the personality styles analyzed in relation to the cultures interacting.

Accordingly, it is a principal object of this invention to provide support for cross cultural interactions. Moreover, it is also an object of this invention to allow for the development of a customized platform for users, including but not limited to allowing for changes to the formats of Graphic User Interfaces (GUI's), touch screens, Interactive Voice Response (IVR) systems, and other interactive platforms.

It is another object of this invention to allow cross cultural interaction support to come from an expert automated knowledge base system or in real-time by cross-cultural experts that can best meet the needs of the end users, based on several factors, including culture, personality, subject matter, and availability.

The present invention will allow for such examples as: a person getting instant cultural information and counsel prior to an assignment in Moscow; a company providing global support as a mechanical engineering team in Detroit collaborates with an engineering design team in Stuttgart and an electrical engineering team in Seoul, prior to launching a new automobile model; and two people in different countries receiving automated advice on cross-culture communication prior to entering into an online negotiation, transaction, or auction; as well as numerous examples.

The present invention will allow for such examples as: providing cultural information for a corporation to coordinate a marketing plan for partners in Brazil, Germany and Saudi Arabia; allowing a government to create and run cultural simulation scenarios enabling embassy staff to improve communication in crisis situations, and providing military teams with a cross-culture map prior to and/or during “in country” missions.

The present invention will allow for such examples as: cultural information delivered via digital collaboration tools to improve global performance and strategic risk management; cultural information loaded into simulation scenarios to help train healthcare workers; and the provision of cultural knowledge management systems and cultural simulation modeling that will allow organizations to collaborate with experts prior to launching products and services in foreign markets.

The present invention will also allow for academic groups to create simulation scenarios to enable students, from diverse cultures and of varied personalities, to collaborate on projects from remote locations.

The present invention will also allow for users and groups to obtain cultural information about said users and groups, as well as how each respective group may feel about a given situation.

An automated information engine is one embodiment of the present invention. Users are also able to use human experts. An automated information sharing platform may consist of, but not be limited to: drop-down menus; categories; lists of countries, languages, genders, age groups, and more. The invention may provide information including but not limited to: culture and personality profiles of customers and prospective customers to facilitate communication and resolve differences and better predict behaviors; in order to facilitate call center workers and other customer service workers in providing higher quality service based on culture and personality parameters. Such a system would help prevent cultural faux pas, which are common in today's internationalized customer service industry and especially in healthcare where such mistakes can result in customer attrition. Other salient business sectors, including e-commerce, m-commerce, law, travel and hospitality, financial services, and non-profit and government organizations, including the Red Cross, UNESCO, the World Bank, Rotary International, and the United Nations would benefit from the components delineated in this invention.

### BRIEF DESCRIPTION OF THE DRAWINGS

FIG. 1 is a flow chart depicting the Summary of Cross-Cultural Interaction Support System and Personality Tool and Method Process of the preferred embodiment.

FIG. 2 is a flow chart depicting the optional selected use of an Expert Knowledge-Based Support of the preferred embodiment.

FIG. 3 is a flow chart depicting the user registration process of the preferred embodiment.

FIG. 4 is a flow chart depicting the provider registration process of the preferred embodiment.

FIG. 5 is a flow chart depicting the listing process of the preferred embodiment.

FIG. 6 is a flow chart depicting the profiling process of the preferred embodiment.

FIG. 7 is a flow chart depicting the matchmaking process of the preferred embodiment.

FIG. 8 is a flow chart depicting the authentication process of the preferred embodiment.

FIG. 9 is a flow chart depicting the scheduling process of the preferred embodiment.

FIG. 10 is a flow chart depicting the reservation process of the preferred embodiment.

FIG. 11 is a flow chart depicting the delivery process of the preferred embodiment.

FIG. 12 is a flow chart depicting the billing process of the preferred embodiment.

FIG. 13 is a flow chart depicting the feedback process of the preferred embodiment.

FIG. 14 is a flow chart depicting the archiving process of the preferred embodiment.

FIG. 15 is a flow chart depicting the rating process of the preferred embodiment.

### DETAILED DESCRIPTION OF THE PREFERRED EMBODIMENTS

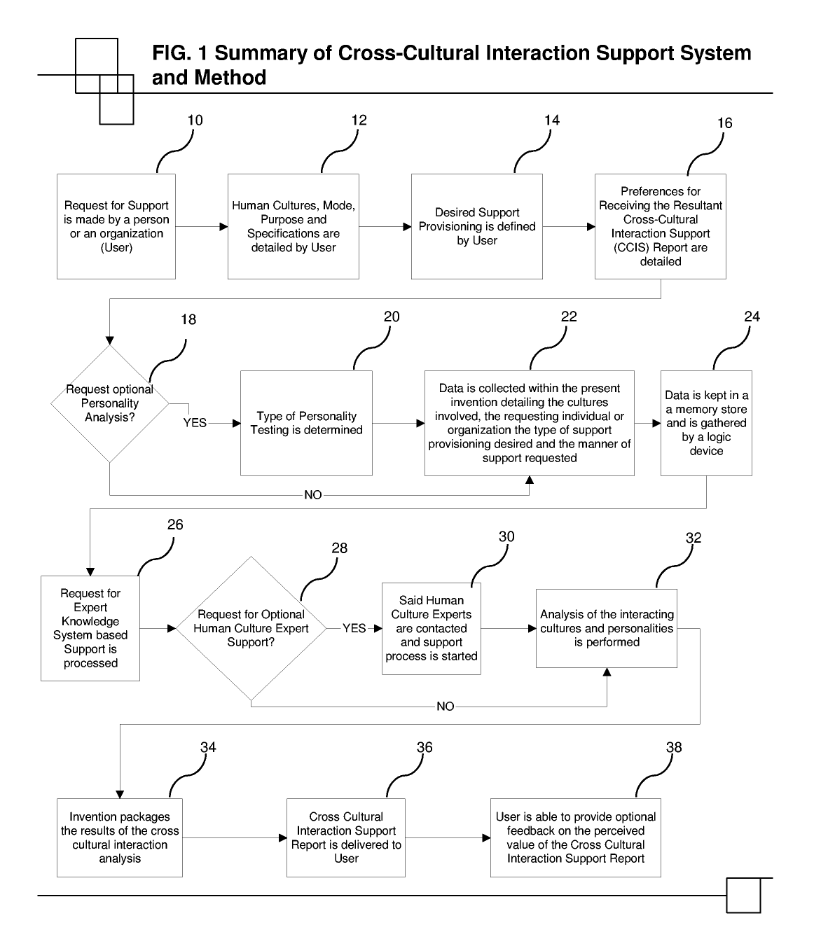

FIG. 1 depicts the overall process of a summary of cross cultural interaction support system and method in which a cross cultural interaction support report is delivered to a user in which a request for support is made by a person or an organization 10. The request itself is made by a plurality of techniques including but not limited to: a telephone call, an online interaction with an interactive system, and a mailed request. This description of the request for support is not intended to limit the manner in which the request for cross cultural interaction support is made. In said request for support, the human cultures involved in the interaction, the mode and purpose of the cross cultural interaction, and any specifications concerning the form and manner of support desired are detailed by user 12. At this point of request for support, the user indicates the type of support provisioning desired 14. Then said requesting individual or organization details their preferences for receiving the resultant Cross Cultural Interaction Support Report 16. Requested delivery preference can be but is not limited to email, voice conversation, online meeting, or paper document. Said request for optional personality analysis 18 can specify the type of testing desired from one or more personality tests 20. As a result of the request for support of cross cultural interaction, data is collected within the present invention detailing the cultures involved, the requesting individual or organization, the type of support provisioning desired, and the manner of support requested 22. This data is kept in a memory store and is gathered by a logic device 24. Said support provisioning can ultimately be: Expert knowledge system based 26; and an option also exists for the user to select support from a Human Culture Expert 28 as well. If the user selects the optional Human cultural expert support 28, then said Human Culture Experts and contacted and the support process is started 30. Said Human Culture Experts are contacted, informed about the cross cultural interaction, the requested support provisioning method, and any optional requests for personality analysis to be processed in conjunction with the cross cultural interaction support 30. In any case, the analysis of the interacting cultures and personalities is performed 32. Said analysis of the interacting cultures 12 include but are not limited to: Process Agreement, Discord, Similarities, Differences, and Approach (ADSDA Analysis). Said expert knowledge system itself is comprised of a memory store that contains cultural information catalogued by human culture and interactive tendency and a logic device that processes the cultural information according to the requests of said requesting individual or organization. This information is initially input from cultural experts. Feedback from processed requests allows the present invention to increase accuracy of future support 38. When said requestor indicated one or more personality analyses protocols to be combined with cross cultural interaction support, the present invention discloses a process for gathering the necessary input via interview with the individuals to be analyzed. Here, the present invention packages the results of the cross cultural interaction analysis 34 regardless of whether it was produced by the expert knowledge system or a human cultural expert. This Cross Cultural Interaction support report is now ready to be presented to the requestor. When the requestor asked for personality analyses, the results of the analyses are then compiled with the results of the cross cultural interaction analysis. This now becomes the Cross Cultural Interaction support report. Said Cross Cultural Interaction Support Report is then delivered to the user 36 in accordance with their chosen method of report delivery. These methods include but are not limited to email, voice, video, personal meeting, online conference, and paper document.

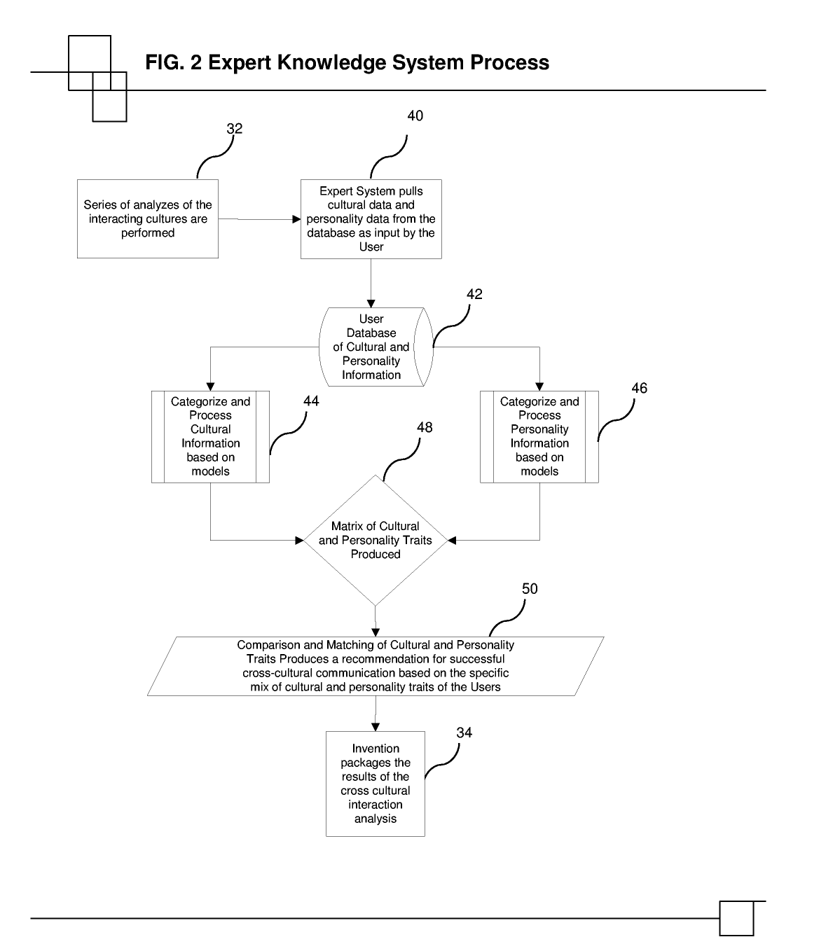

FIG. 2 depicts the overall process of an optional expert knowledge system process in which a series of analyses of the interacting cultures are performed 32, after which the expert system pulls cultural data and personality data from the database as input by the user 40. Information is pulled from the user database of cultural and personality information 42, and then a step to categorize and process cultural information based on models 44 is completed, as well as a step to categorize and process personality information based on models 46. Subsequently, a matrix of cultural and personality traits is produced 48, which then leads to a comparison and matching of cultural and personality traits, thus producing a recommendation for successful cross-cultural communication based on the specific mix of cultural and personality traits of the users 50. Then, the expert system packages the results of the cross-cultural interaction analysis 34.

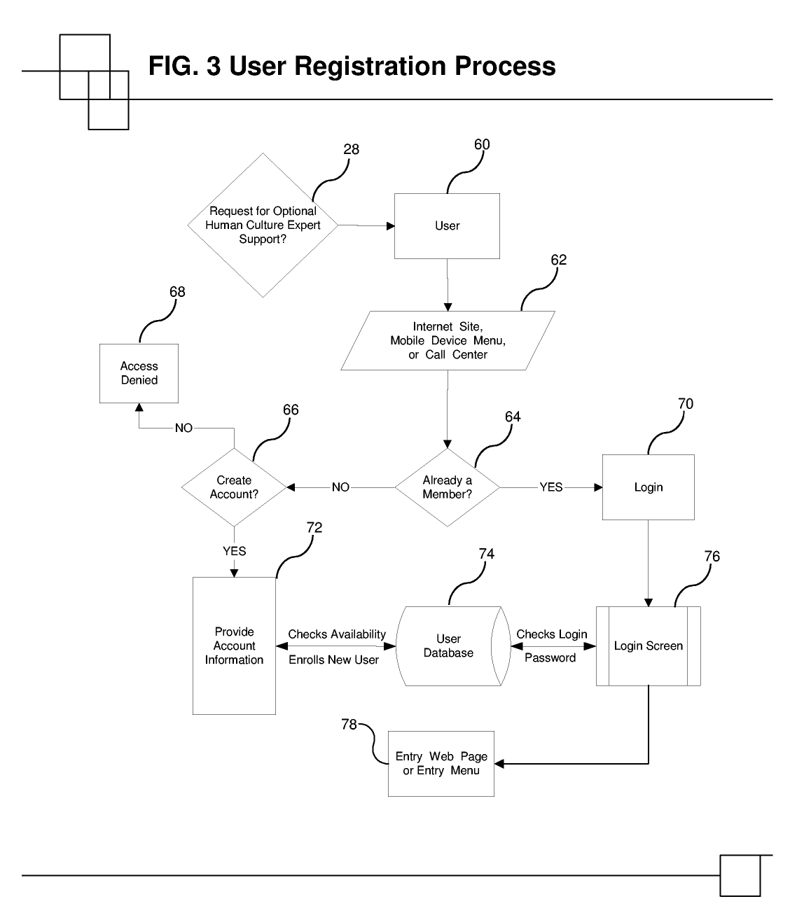

FIG. 3 depicts the overall process of the user registration process of the preferred embodiment where a user 60 enters an Internet site, mobile device menu, or call center 62. If the user is not already a member then said user may decide to create an account 66. If an account is not successfully created access will be denied 68. If the user is already a member they will arrive at a login screen 70. Users that are not members that wish to create an account may be able to provide account information 72 and to successfully arrive at a login screen 76 after which the user may access entry web page or entry menu 78.

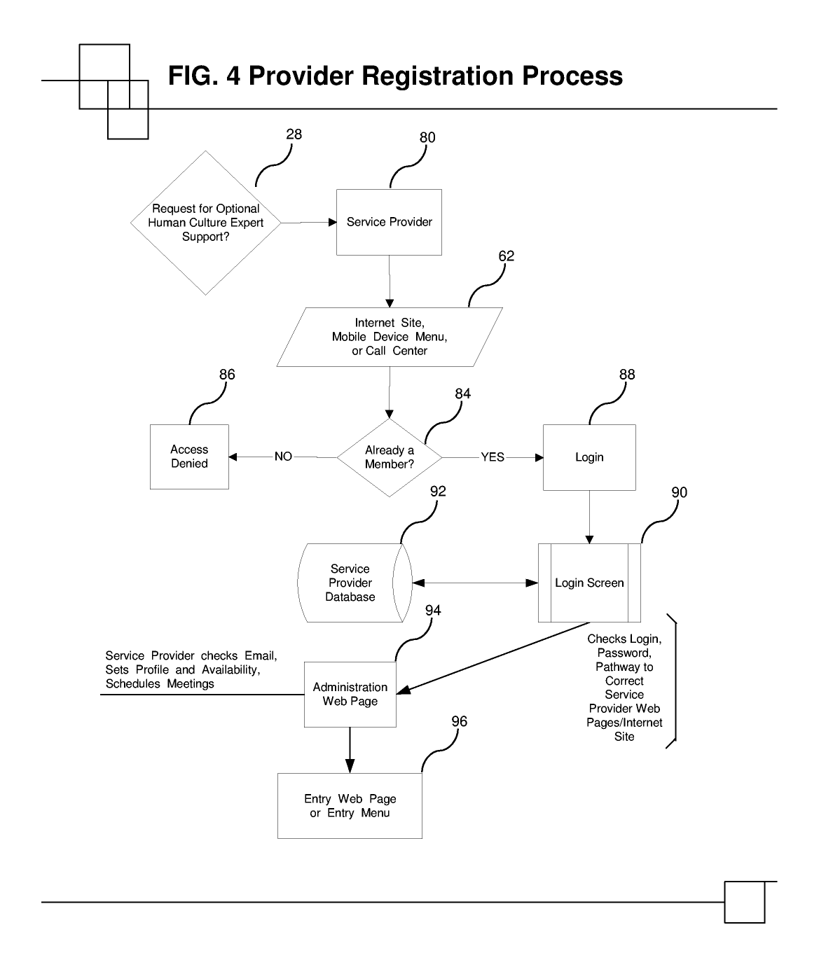

FIG. 4 depicts the provider registration process where a service provider 80 enters an Internet site, mobile device menu, or call center 62. If the service provider is not already a member then said service provider may be denied access 86. If said service provider is denied access then it may be possible for them to gain future access through interfaces including but not limited to an application process involving mailing, face-to-face interview or registration over the Internet. If a service provider is already a member 84 then said service provider will arrive at login 88 and then be transferred to a login screen 90. The login password of the service provider is verified by the service provider database 92 and once completed service provider will arrive at an administration web page 94 before arriving at an entry web page or entry menu 96.

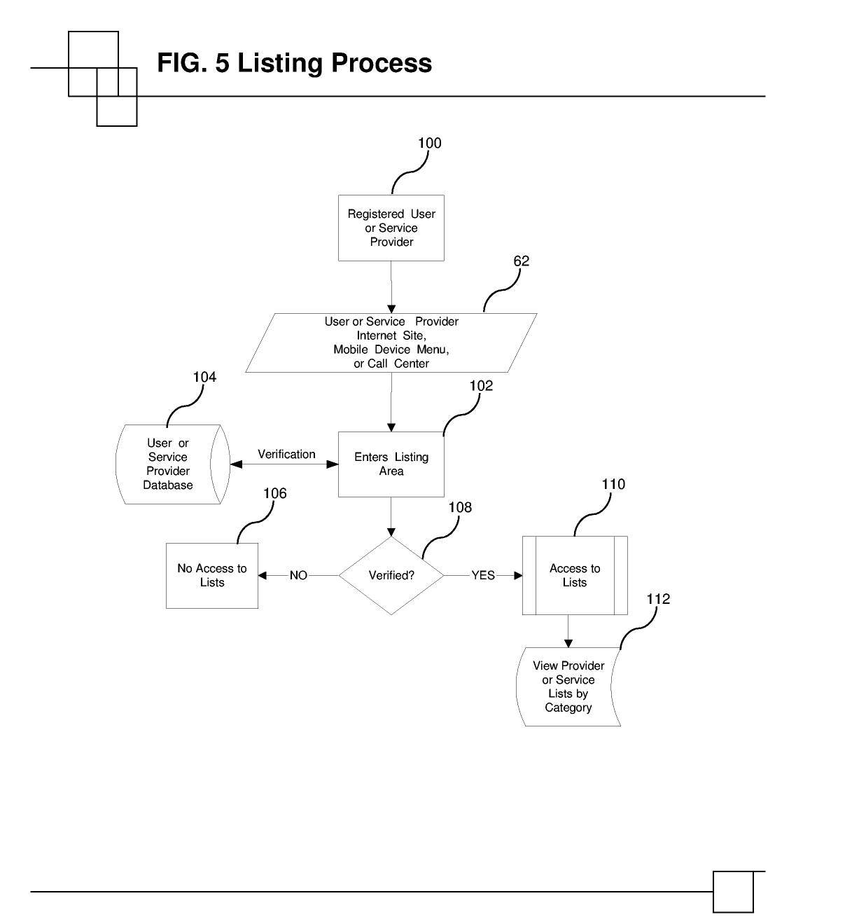

FIG. 5 depicts the listing process whereby a registered user or service provider 100 may enter the user or service provider Internet site, mobile device menu, or call center 62 before entering the listing area 102. Said registered user or service provider 100 must be verified 108. If verified, then access to lists 110 is provided and said registered user or service provider 100 may then view provider or service lists by category 112. If said registered user or service provider 100 is not verified, then no access to lists 106 is granted. Once said registered user or service provider 100 enters the listing area 102, verification against the user or service provider database 104 occurs.

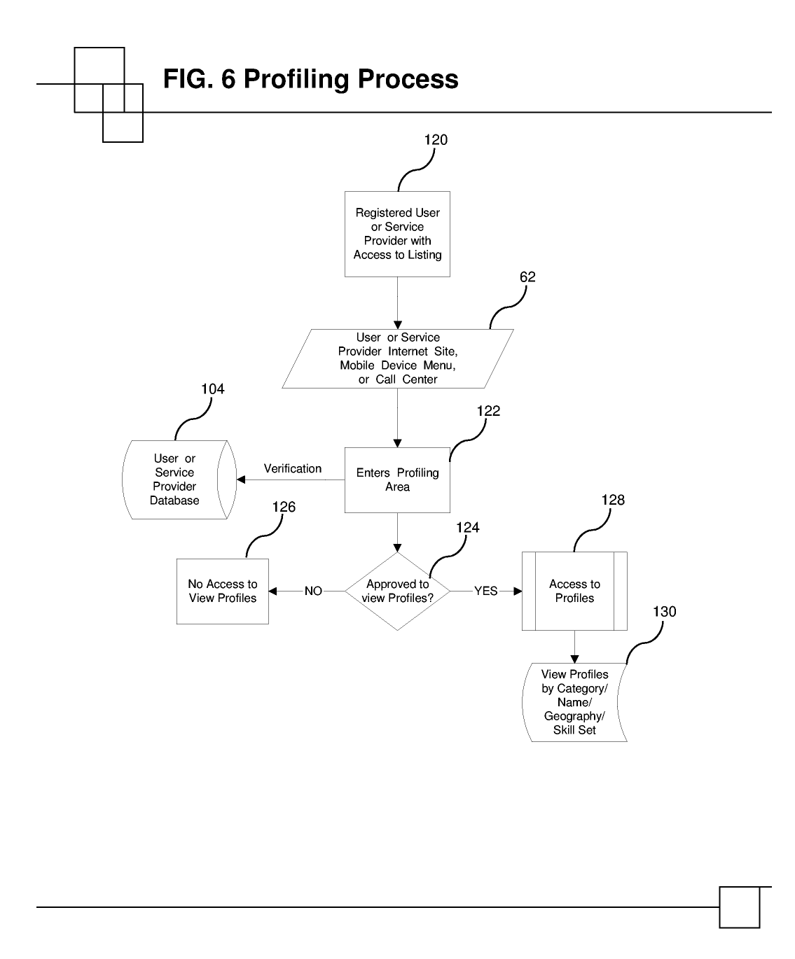

FIG. 6 depicts the profiling process whereby the registered user or service provider with access to listing 120 enters the user or service provider Internet site, mobile device menu, or call center 62 and then thereby enters a profiling area 122 to be verified against the user or service provider database 104. At this point said registered user or service provider with access to listing 120 must be approved to view files 124, and if not approved then no access to view profiles 126 is granted. If said registered user or service provider with access to listing 120 is approved to view profiles 124 then access to profiles 128 is awarded and then said registered user or service provider with access to listing 120 may then view profiles by category/name/geography/skill set 130.

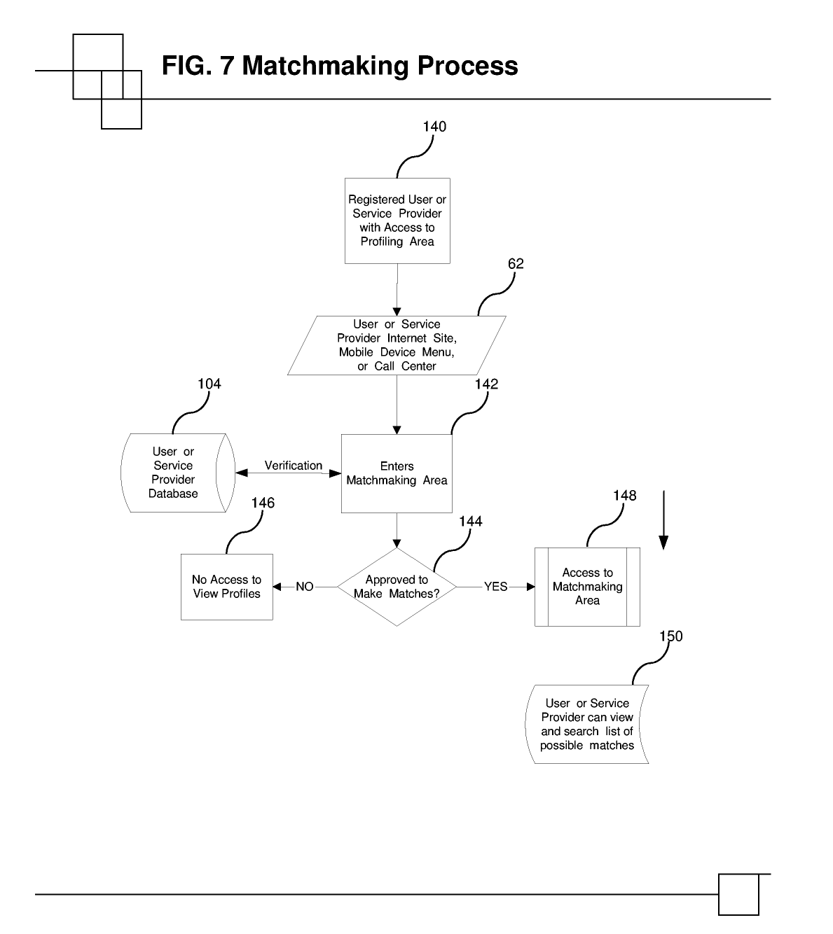

FIG. 7 depicts the matchmaking process whereby a currently registered user or service provider with access to profiling area 140 enters the user or service provider Internet site, mobile device menu, or call center 62, and subsequently entering the matchmaking area 142 were said currently registered user or service provider with access to profiling area 140 is then verified against the user or service provider database 104. Post verification said currently registered user or service provider with access to profiling area 140 must be approved to make matches 144. If said currently registered user service provider with access to profiling area 140 is not approved then no access to view profiles 146 is granted. If said currently registered user or service provider with access to profiling area 140 is approved then access to matchmaking area 148 is granted, and thereby said user or service provider can view and search list of possible matches 150.

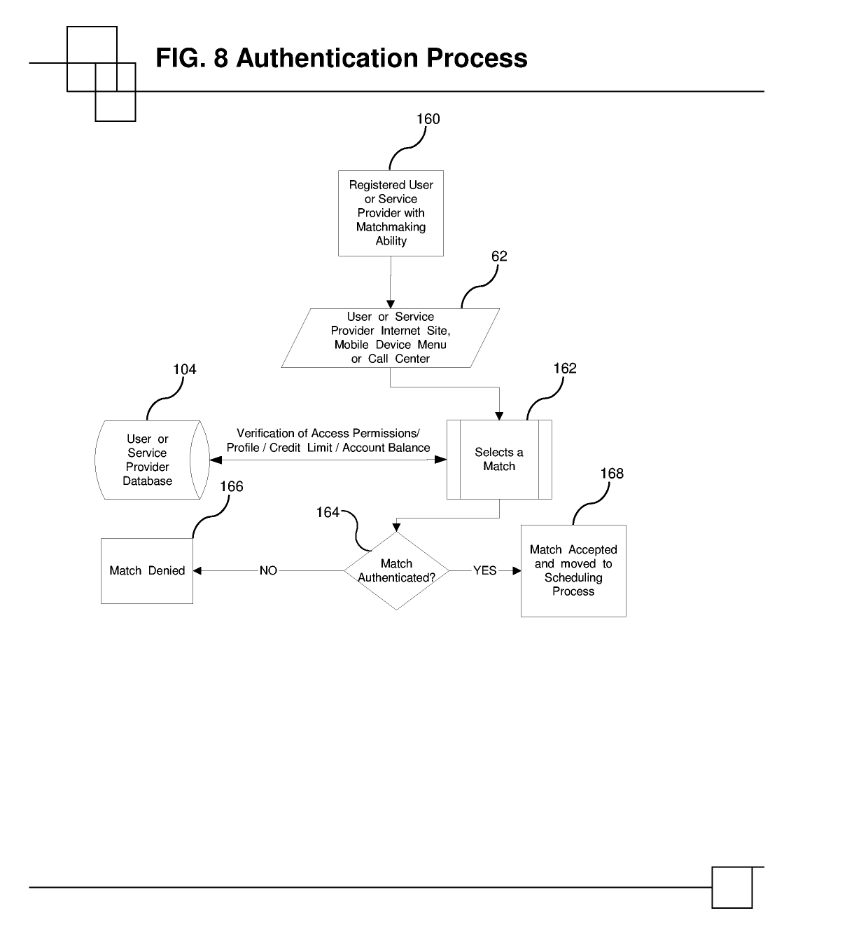

FIG. 8 depicts the authentication process whereby a currently registered user or service provider with matchmaking ability 160 enters the user or service provider Internet site, mobile device menu or call center 62 and is prompted to select a match 162. At this time, verification of access permissions/profiles/credit limit/account balances are performed and matched against the user or service provider database 104. If a match is authenticated then said registered user or service provider with matchmaking ability 160 has match accepted and moves to the scheduling process 168. If a match is not authenticated then the match will be denied 166.

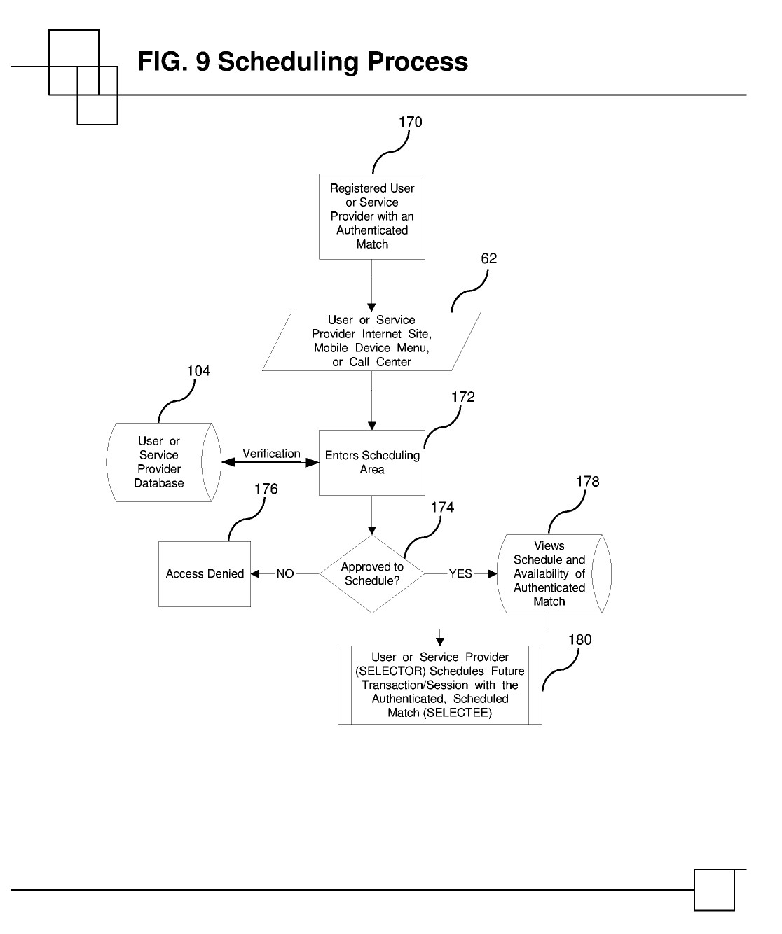

FIG. 9 depicts the scheduling process whereby a registered user or service provider with an authenticated match 170 enters a user or service provider Internet site, mobile device menu, or call center 62 then thereby enters the scheduling area 172, where verification against the user or service provider database 104 occurs. Said registered user or service provider with an authenticated match 170 must be approved to schedule, and if not approved, then access is denied 176. If said registered user or service provider with an authenticated match 170 is approved to schedule then they are able to use schedule and availability of authenticated match 178. At this point the user or service provider seeking the other party will be known as the SELECTOR and may schedule a future transaction/session with the authenticated scheduled match who will be known as the SELECTEE. Ultimately, user or service provider (SELECTOR) schedules future transaction/session with the authenticated, scheduled match (SELECTEE) 180.

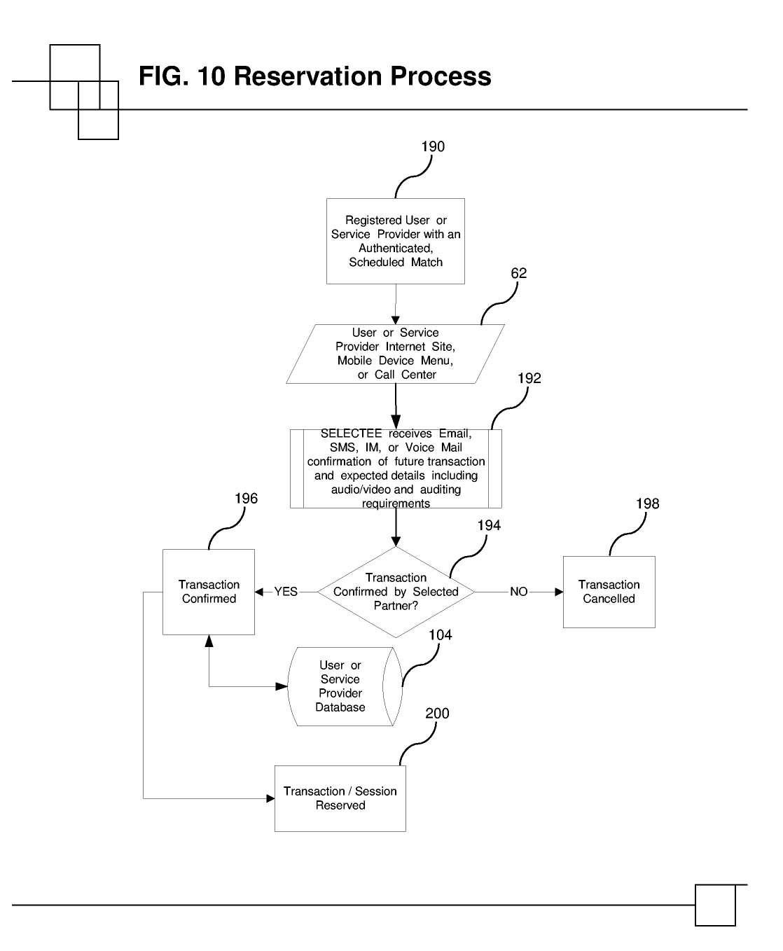

FIG. 10 depicts the reservation process whereby a registered user or service provider with an authenticated, scheduled match 190 enters the user or service provider Internet site, mobile device menu or call center 62 and the SELECTEE, which is a user or service provider whose services are sought after by another called the SELECTOR, receives e-mail, SMS, IM, or voicemail confirmation of future transaction expected details including audio/video and auditing requirements 192. If the transaction is not confirmed by the selected partner, or SELECTEE, then the transaction is canceled 198. If the selected party, or SELECTEE, confirms the transaction 196, then the user or service provider database 104 is updated and the transaction/session is reserved 200.

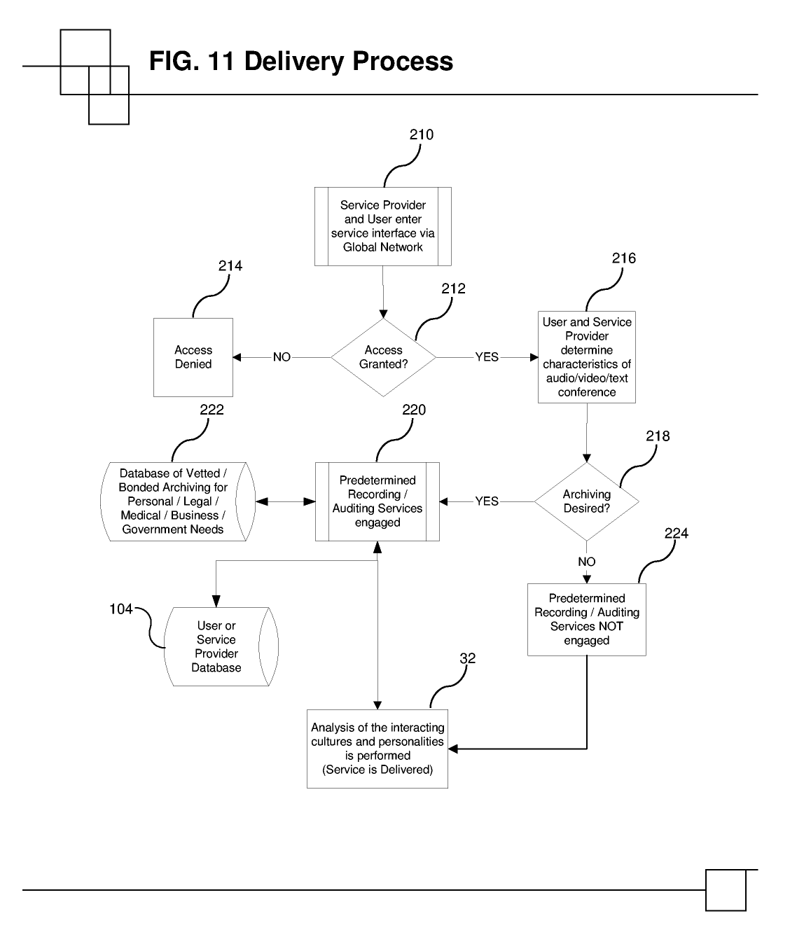

FIG. 11 depicts the delivery process whereby a service provider and user enters service interface via global network 210. Access may or may not be granted, and if not then access is denied 214. If access is granted to said service provider and user, then said service provider and user determine characteristics of audio/video/text conference 216. Archiving may or may not be desired and if not then predetermined recording/audio services are not engaged 224, and then service is delivered 32, and the user or service provider database 104 is updated. If archiving is desired then predetermined recording/audio services are engaged 220 and the user or service provider database 104 is access and updated; whereby, an option to access a database of vetted/bonded archiving for personal/legal/medical/business/government needs 222 may also occur, as well as another option interface to a third-party database. The delivery features of the invention depicted in FIG. 10 deliver provider services of cross cultural information across a plurality of media. Each user session can use a different Global Network 210 media including but not limited to telephony, internet modalities, video conference, speech to text, or text to speech. Once access is granted 212 the user and provider select the communication media, the archiving requirement, and any third party involvement 216. In one example of the invention, users will be presubscribed to a specific media. In another example of the invention, a user will have an ad hoc and spontaneous need for a media, which may or may not be different from said users predetermined media. In other examples of the invention, users will not have to be presubscribed to any media. The invention then evaluates the archiving decision made by the user and provider 216 and if needed invokes chosen prerecording or auditing services 224. In one example of the invention, the user and provider may have chosen to have the information exchange audited and recorded. Once the logistical support of archiving, auditing, and third party involvement is provisioned, the actual information exchange and service delivery 32 begins. In one example of the current invention, the service delivery 32 involves unarchived, unaudited cultural and personality communication interpretation involving a third party for a user in a foreign land via telephone or other communications device. In another example of the current invention, the cultural information exchange involves archived cultural information about how a doctor should greet a patient form another culture.

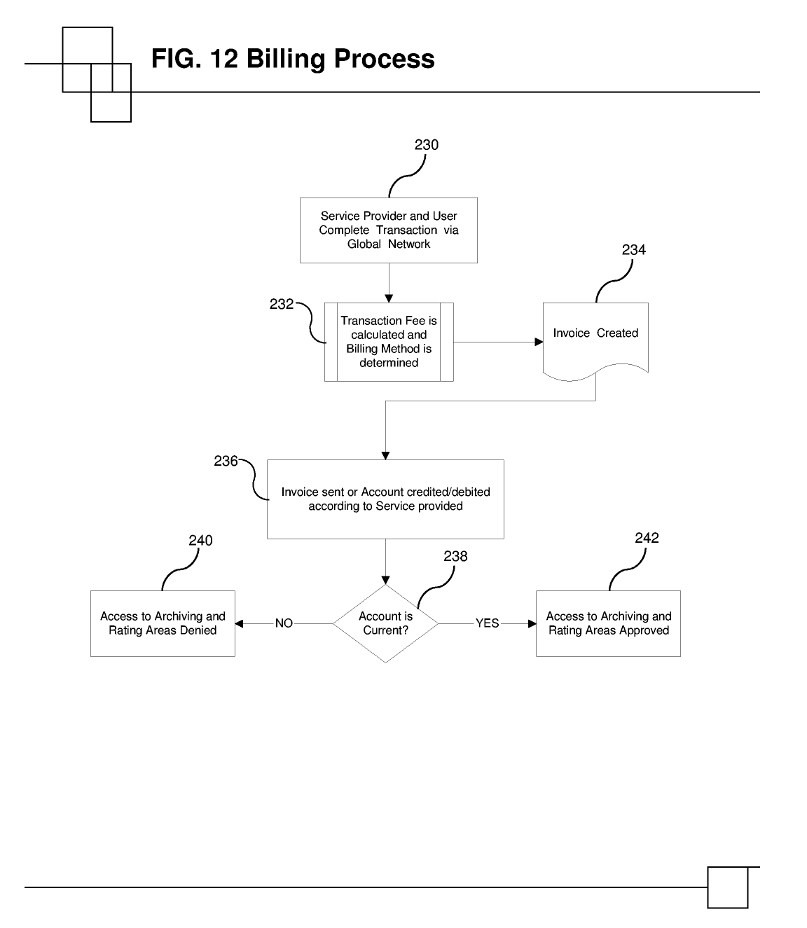

FIG. 12 depicts the billing process whereby a service provider and user complete transaction via global network 230 and the transaction fee is calculated and billing method is determined 232, thereby creating an invoice 234. Said it invoice 234 is sent or the account is credited/debited according to the service provided 236. If the account is not current then access to archiving and rating areas are denied 240. If the account is current then access to archiving and rating areas is approved 242.

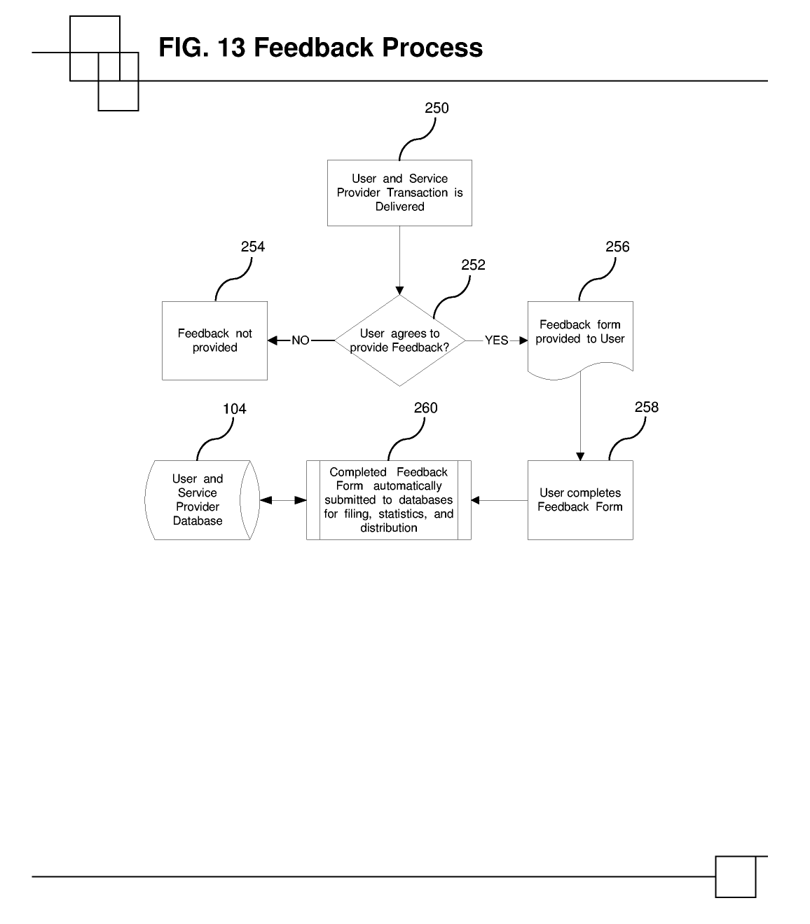

FIG. 13 depicts the feedback process whereby a user and service provider transaction is delivered 250. If said user does not agree to provide feedback then feedback is not provided 254. If said user agrees to provide feedback than feedback form is provided 256 and said user completes feedback form 258. Once said user has completed feedback form then completed feedback form automatically is submitted to databases for filing, statistics and distribution 260 and user and service provider database 104 is accessed and updated.

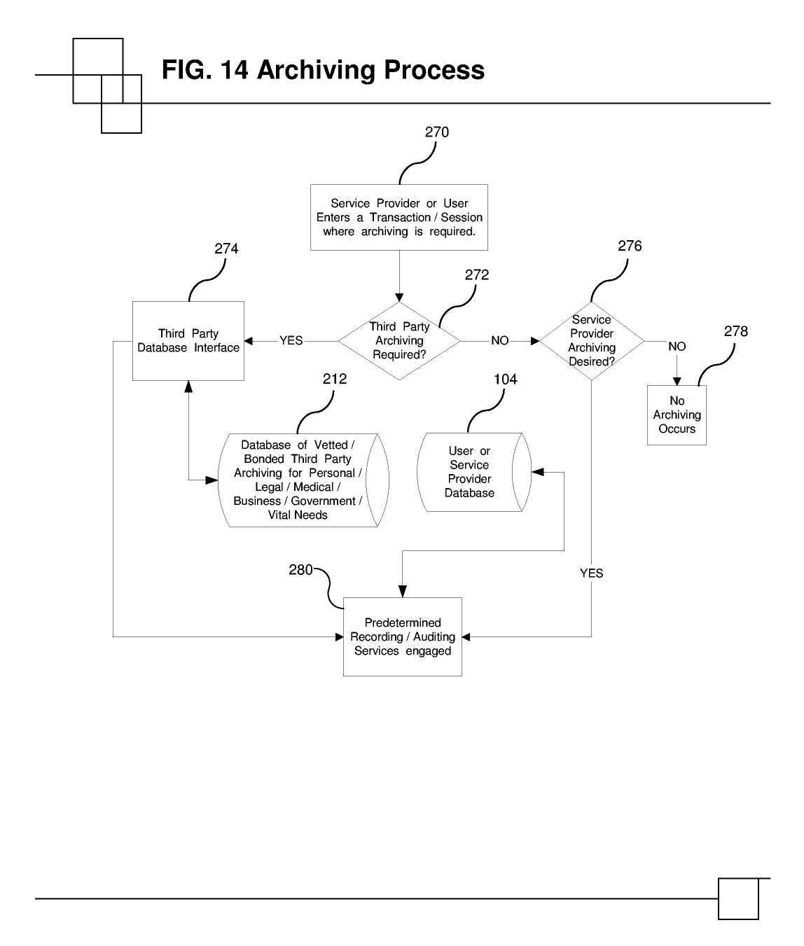

FIG. 14 depicts the archiving process whereby a service provider or user enters a transaction/session where archiving is required 270. If a third-party archiving is not required, and then service provider archiving is also not required then no archiving occurs 278. It no third-party archiving is required; however, service provider archiving is desired then the predetermined recording/auditing services are engaged 280 and the user or service provider database 104 is accessed and updated. If third-party archiving is required then a third-party database interface 274 will access and update a database of vetted/bonded third-party archiving for personal/legal/medical/business/government/vital needs 212, and then predetermined recording/auditing services are engaged 280.

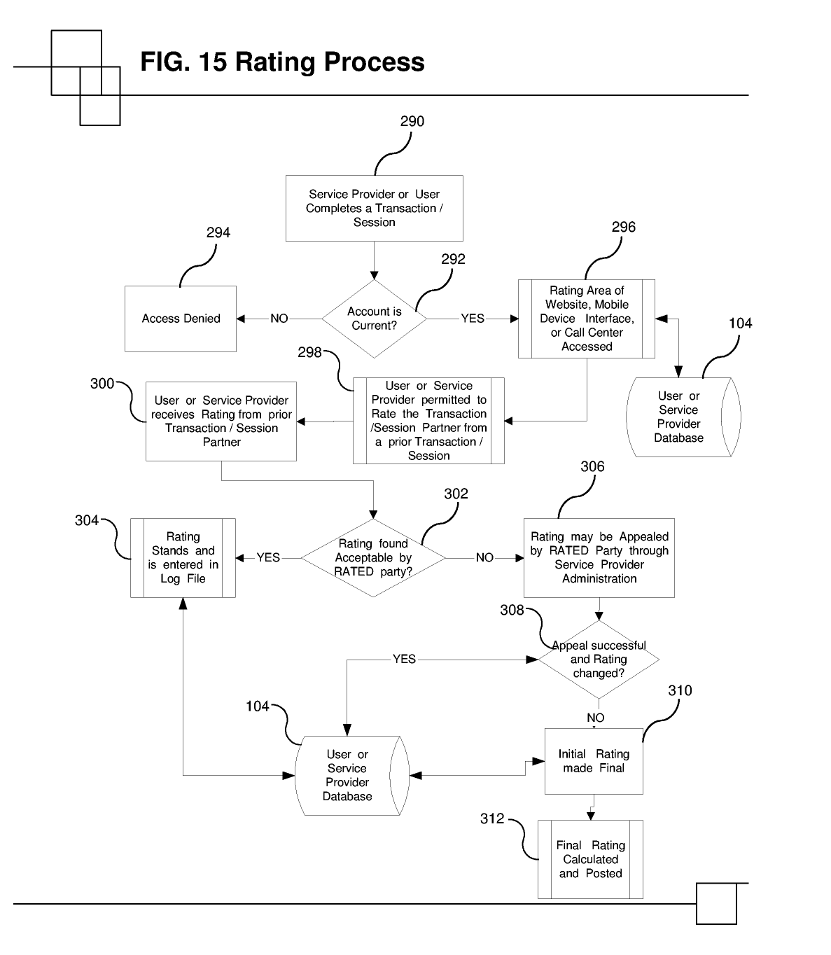

FIG. 15 depicts the rating process whereby a service provider or user completes a transaction/session 290. If the account is not current then access is denied 294. If the account is current then the rating area of web site mobile device interface for call-center is accessed 296, and the user or service provider database 104 is accessed and updated. At this point said user or service provider is permitted to rate the transaction/session partner from a prioress transaction/session 298 and a service provider may receive a rating from a prior transaction/session partner 300. If said rating is found acceptable by the rated party than the rating stands in this entered into the log file 304, and said user or service provider database 104 is accessed and updated. If said rating is not found acceptable by the rated party than said rating may be appealed by rated party through service provider administration 306. If said appeal is successful and rating is to be changed, then said user or service provider database 104 is accessed, and the new rating stands and is entered in log file 304. If said appeal is not successful and rating is not changed then initial rating is made final 310, and then final rating is calculated and posted 312.

What is claimed is:

1. A system and method for supporting cross cultural interactions.

2. A system and method as recited in claim 1 wherein the support is provided by an expert knowledge system.

3. A system and method as recited in claim 1 wherein the support is provided by an expert knowledge system comprised of a logic device and a memory store.

4. A system and method as recited in claim 1 wherein the support is defined as information.

5. A system and method as recited in claim 1 wherein the support is defined as strategic information.

6. A system and method as recited in claim 1 wherein the support is defined as one or more suggestions.

7. A system and method as recited in claim 1 wherein the support is defined as one or more instructions.

8. A system and method as recited in claim 1 wherein the support is defined as any combination of information, strategies, and suggestions.

9. A system and method as recited in claim 1 wherein the support is provided by human cultural experts.

10. A system and method as recited in claim 1 wherein the support is provided by human cultural experts availing themselves of an expert knowledge system.

11. A system and method for supporting cross cultural interactions including individual personality analyses.

12. A system and method as recited in claim 10 where in the support is provided by an expert knowledge system and a standardized personality analysis test.

13. A system and method as recited in claim 10 wherein the support is provided by an expert knowledge system comprised of a logic device and a memory store and a standardized personality analysis that is comprised of a logic device and a memory store.

14. A system and method as recited in claim 10 wherein the support is defined as information.

15. A system and method as recited in claim 10 wherein the support is defined as strategic information.

16. A system and method as recited in claim 10 wherein the support is defined as one or more suggestions.

17. A system and method as recited in claim 10 wherein the support is defined as any combination of information, strategies, and suggestions.

18. A system and method as recited in claim 10 wherein the support is provided by human cultural experts and human behavioral experts.

19. A system and method as recited in claim 10 wherein the support is provided by human cultural experts availing themselves of an expert knowledge system and a standardized personality test.
